(19) United States
(12) Patent Application Publication
(10) Pub. No.: US 2020/0183315 A1
(43) Pub. Date: Jun. 11, 2020

(54) IMAGE FORMING APPARATUS, DETERIORATION STATE DETECTION METHOD AND NON-TRANSITORY COMPUTER-READABLE RECORDING MEDIUM ENCODED WITH DETERIORATION STATE DETECTION PROGRAM

(71) Applicant: KONICA MINOLTA, INC., Tokyo (JP)

(72) Inventor: Noritoshi HAGIMOTO, Toyohashi-shi (JP)

(73) Assignee: KONICA MINOLTA, INC., Tokyo (JP)

(21) Appl. No.: 16/674,320

(22) Filed: Nov. 5, 2019

(30) Foreign Application Priority Data
Dec. 5, 2018 (JP) 2018-228404

(51) Int. Cl. G03G 15/00

(52) U.S. Cl. CPC G03G 15/556

(57) ABSTRACT

An image forming apparatus includes a developing device that stores a developer including toner, an image carrier that carries a toner image produced by part of the toner stored in the developing device, and a controller, wherein the controller determines a deterioration state of the toner, immediately before being supplied to a recording medium from the image carrier, based on a deterioration amount correlating to deterioration of the toner stored in the developing device.

The entire disclosure of Japanese patent Application No. 2018-228404 filed on Dec. 5, 2018, is incorporated herein by reference in its entirety.

### BACKGROUND

### Technological Field

The present invention relates to an image forming apparatus, a deterioration state detection method and a non-transitory computer-readable recording medium encoded with a deterioration state detection program. In particular, the present invention relates to an image forming apparatus that forms an image using a developer constituted by non-magnetic toner and a magnetic carrier, a deterioration state detection method that is executed in the image forming apparatus and a non-transitory computer-readable recording medium encoded with a deterioration state detection program that allows a computer to execute the deterioration state detection method.

### Description of the Related Art

An image forming apparatus that is represented by an MFP (Multi Function Peripheral) frictionally charges a developer constituted by non-magnetic toner and a magnetic carrier by stirring them in a developing device, and forms a toner image on a photoreceptor drum by applying electrical charge to toner particles. Physical stress is applied to the developer when the developer is stirred in the developing device, whereby an external additive added to the toner may be separated from the toner, buried in the toner, etc. Thus, the toner may deteriorate. When the toner deteriorates, functions such as developability and transferability of toner are degraded. Thus, quality of images formed by the toner is degraded.

As a technique to deal with this problem, the technique for executing toner refresh control in order to prevent the average number of papers the toner that is in the developing device can print from becoming equal to or higher than a certain number of papers is described in Japanese Patent Laid-Open No. 2016-62023.

However, the toner in the developing device is transferred to a paper through an image carrier such as a photoreceptor drum from the developing device. Thus, there is a problem that the deterioration state of the toner immediately before being transferred to a paper cannot be determined by the technique described in Japanese Patent Laid-Open No. 2016-62023.

### SUMMARY

According to one aspect of the present invention, an image forming apparatus includes a developing device that stores a developer including toner, an image carrier that carries a toner image produced by part of the toner stored in the developing device, and a controller, wherein the controller determines a deterioration state of the toner, immediately before being supplied to a recording medium from the image carrier, based on a deterioration amount correlating to deterioration of the toner stored in the developing device.

According to another aspect of the present invention, a deterioration state detection method is executed in an image forming apparatus, wherein the image forming apparatus includes a developing device that stores a developer including toner, and an image carrier that carries a toner image produced by part of the toner stored in the developing device, and the deterioration state detection method includes a deterioration state determining step of determining a deterioration state of the toner, immediately before being supplied to a recording medium from the image carrier, based on a deterioration amount correlating to deterioration of the toner stored in the developing device.

According to yet another aspect of the present invention, a non-transitory computer-readable recording medium is encoded with a deterioration state detection program executed by a computer controlling an image forming apparatus, wherein the image forming apparatus includes a developing device that stores a developer including toner, and an image carrier that carries a toner image produced by part of the toner stored in the developing device, and the deterioration state detection program allows the computer to execute a deterioration state determining step of determining a deterioration state of the toner, immediately before being supplied to a recording medium from the image carrier, based on a deterioration amount correlating to deterioration of the toner stored in the developing device.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a perspective view showing the appearance of an MFP in a first embodiment of the present invention;

FIG. 2 is a block diagram showing the outline of a hardware configuration of the MFP in the present embodiment;

FIG. 3 is a schematic cross sectional view showing the inner configuration of the MFP;

FIG. 4 is a cross sectional view of a developing device;

FIG. 5 is a diagram showing the change in image quality rank;

FIG. 6 is a diagram showing one example of the change in deterioration state of toner stored in the developing device;

FIG. 7 is a diagram showing one example of the Si ratio of the toner stored in the developing device and the Si ratio of the toner that constitutes a toner image formed on an intermediate transfer belt;

FIG. 8 is a diagram showing one example of distribution of the Si ratio of new toner stored in the developing device and the Si ratio of deteriorated toner;

FIG. 9 is a diagram showing one example of the variance and the selected percentage of the Si ratio of the toner stored in the developing device;

FIG. 10 is a block diagram showing one example of functions of a CPU included in an MFP in the present embodiment;

FIG. 11 is a flow chart showing one example of a flow of a supply control process;

FIG. 12 is a flow chart showing one example of a flow of a deterioration state detection process; and

FIG. 13 is a flow chart showing one example of a flow of a toner refresh control process.

### DETAILED DESCRIPTION OF EMBODIMENTS

Hereinafter, one or more embodiments of the present invention will be described with reference to the drawings. However, the scope of the invention is not limited to the disclosed embodiments.

Embodiments of the present invention will be described below with reference to the drawings. In the following description, the same parts are denoted with the same reference characters. Their names and functions are also the same. Thus, a detailed description thereof will not be repeated.

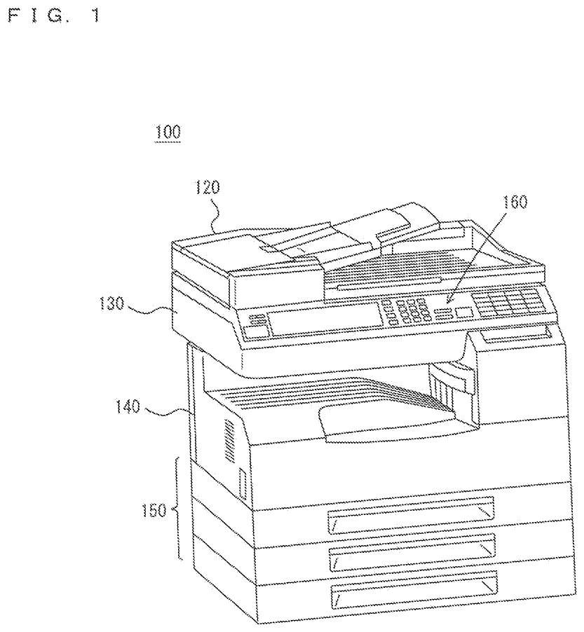

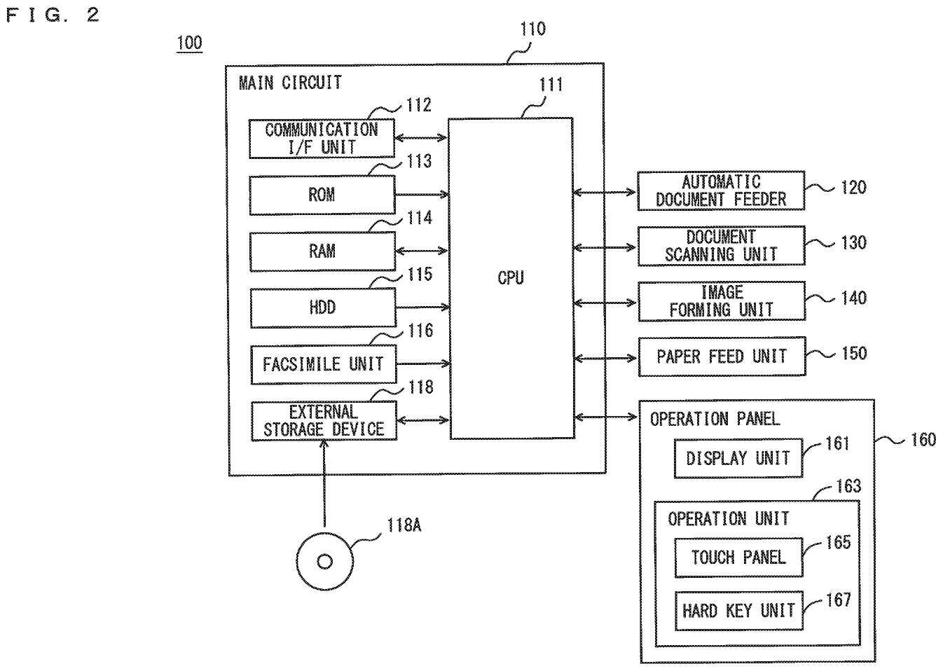

FIG. 1 is a perspective view showing the appearance of an MFP in a first embodiment of the present invention. FIG. 2 is a block diagram showing the outline of the hardware configuration of the MFP in the first embodiment. Referring to FIGS. 1 and 2, the MFP (Multi Function Peripheral) 100 is one example of an image processing apparatus and includes a main circuit 110, a document scanning unit 130 for scanning a document, an automatic document feeder 120 for conveying a document to the document scanning unit 130, an image forming unit 140 for forming an image on a paper (a sheet of paper) based on image data, a paper feed unit 150 for supplying the paper to the image forming unit 140, and an operation panel 160 serving as a user interface.

The automatic document feeder 120 automatically conveys a plurality of documents set on a document tray to a document scanning position of the document scanning unit 130 one by one, and discharges the document having an image that has been scanned by the document scanning unit 130 to a document discharge tray.

The document scanning unit 130 has a rectangular scan surface for scanning a document. The scan surface is formed of a platen glass, for example. The automatic document feeder 120 is connected to the main body of the MFP 100 to be rotatable about an axis in parallel to one edge of the scan surface and can be open or closed. The document scanning unit 130 is arranged below the automatic document feeder 120, and the scan surface of the document scanning unit 130 is exposed in an open state where the automatic document feeder 120 is opened after being rotated. Therefore, a user can place a document on the scan surface of the document scanning unit 130. The automatic document feeder 120 can change between an open state where the scan surface of the document scanning unit 130 is exposed and a close state where the scan surface is covered.

The image forming unit 140 forms an image on a paper conveyed by the paper feed unit 150 using a well-known electrophotographic method. In the present embodiment, the image forming unit 140 forms an image on the paper conveyed by the paper feed unit 150 according to an image forming condition corresponding to the image data and the medium type of a paper. The paper on which an image is formed is discharged to a paper discharge tray 159.

The main circuit 110 includes a CPU (Central Processing Unit) 111 that controls the MFP 100 as a whole, a communication interface (I/F) unit 112, a ROM (Read Only Memory) 113, a RAM (Random Access Memory) 114, a hard disk drive (HDD) 115 as a mass storage device, a facsimile unit 116 and an external storage device 118. The CPU 111 is one example of a computer that executes a program. The CPU 111 executes the program, thereby being connected to the automatic document feeder 120, the document scanning unit 130, the image forming unit 140, the paper feed unit 150 and the operation panel 160, and controlling the MFP 100 as a whole.

The ROM 113 stores a program to be executed by the CPU 111 or data necessary for execution of the program. The RAM 114 is used as a work area when the CPU 111 executes the program. Further, the RAM 114 temporarily stores image data successively transmitted from the document scanning unit 130.

The operation panel 160 is provided in an upper part of the MFP 100. The operation panel 160 includes a display unit 161 and an operation unit 163. The display unit 161 is a Liquid Crystal Display (LCD), for example, and displays instruction menus to users, information about the acquired image data and other information. For example, an organic EL (Electroluminescence) display can be used instead of the LCD as long as the device displays images.

The operation unit 163 includes a touch panel 165 and a hard key unit 167. The touch panel 165 is a capacitance type. Not only the capacitance type but also another type such as a resistive film type, a surface acoustic wave type, an infrared type and an electromagnetic induction type can be used for the touch panel 165.

The detection surface of the touch panel 165 is provided to be superimposed on the upper surface or the lower surface of the display unit 161. Here, the size of the detection surface of the touch panel 165 is equal to the size of the display surface of the display unit 161. Thus, the coordinate system of the display surface and the coordinate system of the detection surface are the same. The touch panel 165 detects the position designated by the user in the display surface of the display unit 161 and outputs the coordinates of the detected position to the CPU 111. The coordinate system of the display surface and the coordinate system of the detection surface are the same, so that the coordinates output by the touch panel 165 can be replaced by the coordinates of the display surface.

The hard key unit 167 includes a plurality of hard keys. The hard keys are contact switches, for example. The touch panel 165 detects the position designated by the user in the display surface of the display unit 161. In the case where operating the MFP 100, the user is likely to be in an upright attitude. Thus, the display surface of the display unit 161, the operation surface of the touch panel 165 and the hard key unit 167 are arranged to face upward. This is for the purpose of enabling the user to easily view the display surface of the display unit 161 and easily give an instruction using the operation unit 163 with his or her finger.

The communication I/F unit 112 is an interface for connecting the MFP 100 to the network. The communication I/F unit 112 communicates with another computer connected to the network or a data processing device connected to the network using a communication protocol such as a TCP (Transmission Control Protocol) or an FTP (File Transfer Protocol). The network to which the communication I/F unit 112 is connected is a Local Area Network (LAN), either wired or wireless. Further, the network is not limited to the LAN and may be a Wide Area Network (WAN), a Public Switched Telephone Networks (PSTN), the Internet or the like.

The facsimile unit 116 is connected to the Public Switched Telephone Network (PSTN), and transmits facsimile data to or receives facsimile data from the PSTN. The facsimile unit 116 stores the received facsimile data in the HDD 115, converts the received facsimile data into print data that is printable in the image forming unit 140 and outputs the print data to the image forming unit 140. Thus, the image forming unit 140 forms the image represented by the facsimile data received from the facsimile unit 116 on a paper. Further, the facsimile unit 116 converts the data stored in the HDD 115 into facsimile data, and transmits the facsimile data to a facsimile machine connected to the PSTN.

The external storage device 118 is controlled by the CPU 111 and mounted with a CD-ROM (Compact Disk Read Only Memory) 118A or a semiconductor memory. While the CPU 111 executes the program stored in the ROM 113 by way of example in the present embodiment, the CPU 111 may control the external storage device 118, read out the program to be executed by the CPU 111 from the CD-ROM 118A and store the read program in the RAM 114 for execution.

The CPU 111 controls the image forming unit 140 and allows the image forming unit 140 to form an image of the image data on a recording medium such as a paper. The image data output by the CPU 111 to the image forming unit 140 includes image data such as externally received print data in addition to the image data received from the document scanning unit 130.

The recording medium for storing the program to be executed by the CPU 111 is not limited to the CD-ROM 118A. It may be a flexible disc, a cassette tape, an optical disc (MO (Magnetic Optical Disc)/MD (Mini Disc)/DVD (Digital Versatile Disc)), an IC card, an optical card, and a semiconductor memory such as a mask ROM or an EPROM (Erasable Programmable ROM). Further, the CPU 111 may download the program from the computer connected to the network and store the program in the HDD 115. Alternatively, the computer connected to the network may write the program in the HDD 115, and then the program stored in the HDD 115 may be loaded into the RAM 114 to be executed in the CPU 111. The program referred to here includes not only a program directly executable by the CPU 111 but also a source program, a compressed program, an encrypted program or the like.

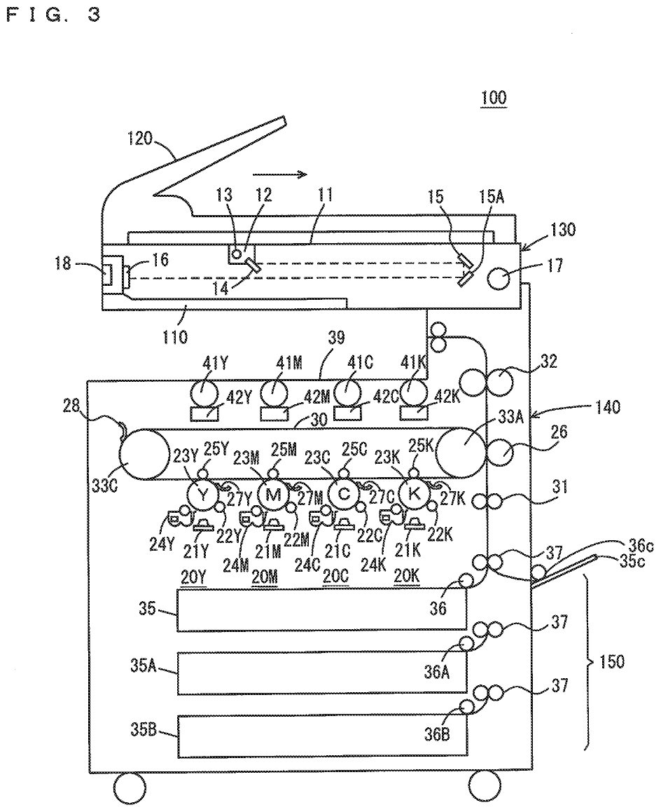

FIG. 3 is a schematic cross sectional view showing the inner configuration of the MFP. Referring to FIG. 3, the automatic document feeder 120 sorts one or more documents placed on the document tray and conveys the documents to the document scanning unit 130 one by one. The document scanning unit 130 exposes an image on a document set on a document glass 11 by the automatic document feeder 120 using an exposure lamp 13 attached to a slider 12 moving below. The light reflected from the document is led to a lens 16 by a mirror 14 and two reflection mirrors 15, 15A, and forms an image in a CCD (Charge Coupled Devices) sensor 18. The exposure lamp 13 and the mirror 14 are attached to the slider 12, and the slider 12 is moved by a scanner motor 17 in the direction (a sub-scanning direction) indicated by the arrow in FIG. 3 at a speed V corresponding to a magnification ratio. Thus, the entire document set on the document glass 11 can be scanned. Further, the two reflection mirrors 15, 15A move in the direction indicated by the arrow in the FIG. 3 at a speed V/2 due to the movement of the exposure lamp 13 and the mirror 14. Thus, the optical path length of the light emitted to the document by the exposure lamp 13 from the position at which the light is reflected from the document to the position at which the light forms an image in the CCD sensor 18 is constant at all times.

The reflected light that has formed an image in the CCD sensor 18 is converted in the CCD sensor 18 into image data as an electric signal. The image data is converted into print data for cyan (C), magenta (M), yellow (Y) and black (K), and is output to the image forming unit 140.

The image forming unit 140 includes respective image forming units 20Y, 20M, 20C, 20K for respective yellow, magenta, cyan and black. Here, “Y,” “M,” “C” and “K” respectively represent yellow, magenta, cyan and black. At least one of the image forming units 20Y, 20M, 20C, 20K is driven, so that an image is formed. When all of the image forming units 20Y, 20M, 20C, 20K are driven, a full color image is formed. The print data for yellow, magenta, cyan and black are respectively input in the image forming units 20Y, 20M, 20C, 20K. The only difference among the image forming units 20Y, 20M, 20C, 20K is the color of toner handled by the image forming units 20Y, 20M, 20C, 20K. Here, the image forming unit 20Y for forming an image in yellow will be described.

The image forming unit 20Y includes an exposure device 21Y to which the print data for yellow is input, a photoreceptor drum 23Y which is an image carrier, a charging roller 22Y for charging the surface of the photoreceptor drum 23Y uniformly, a developing device 24Y, a first transfer roller 25Y for transferring a toner image formed on the photoreceptor drum 23Y onto an intermediate transfer belt 30 using the effect of an electric field force, a drum cleaning blade 27Y for removing transfer residual toner on the photoreceptor drum 23Y, a toner bottle 41Y and a toner hopper 42Y.

The toner bottle 41Y stores yellow toner. The toner bottle 41Y rotates while using a toner bottle motor as a drive source. Spiral projections are formed on the inner wall of the toner bottle 41Y. When the toner bottle 41Y rotates, the toner moves along the projections and is discharged to the outside of the toner bottle 41Y. The toner discharged from the toner bottle 41Y is supplied to the toner hopper 42Y. The toner hopper 42Y includes a storage chamber for storing toner, a screw provided below the storage chamber and a toner replenishing motor that rotates the screw. A connection member that is connected to the developing device 24Y is attached to a position in the vicinity of the end of the screw of the storage chamber. The toner hopper 42Y supplies the toner to the developing device 24Y when the remaining amount of toner stored in the developing device 24Y becomes equal to or lower than a predetermined lower limit value. Specifically, when the toner replenishing motor rotates the screw, the toner stored in the storage chamber moves along the screw, and the toner is supplied to the developing device 24Y through the connection member. The amount of toner supplied to the developing device 24Y is adjusted by adjusting the rotation amount of the screw of the toner hopper 42Y.

The charging roller 22Y, the exposure device 21Y, the developing device 24Y, the first transfer roller 25Y and the drum cleaning blade 27Y are arranged around the photoreceptor drum 23Y in order in a rotation direction of the photoreceptor drum 23Y.

After being charged by the charging roller 22Y, the photoreceptor drum 23Y is irradiated with laser light emitted by the exposure device 21Y. The exposure device 21Y exposes the portion corresponding to an image on the surface of the photoreceptor drum 23Y and forms an electrostatic latent image. Thus, the electrostatic latent image is formed on the photoreceptor drum 23Y. Subsequently, the developing device 24Y develops the electrostatic latent image formed on the photoreceptor drum 23Y using the charged toner and the effect of the electric field force. Thus, the toner image is formed on the photoreceptor drum 23Y when the toner is applied onto the electrostatic latent image. The toner image formed on the photoreceptor drum 23Y is transferred onto the intermediate transfer belt 30, which is an image carrier, by the first transfer roller 25Y with use of the effect of the electric field force. The toner that is not used and is residual on the receptor drum 23Y is removed from the photoreceptor drum 23Y by the drum cleaning blade 27Y.

On the other hand, the intermediate transfer belt 30 is suspended by a drive roller 33C and a roller 33A not to loosen. When the drive roller 33C rotates in an anti-clockwise direction in FIG. 3, the intermediate transfer belt 30 rotates in the anti-clockwise direction in the diagram at a certain speed. The roller 33A rotates in the anti-clockwise direction as the intermediate transfer belt 30 rotates.

Thus, the image forming units 20Y, 20M, 20C, 20K sequentially transfer toner images onto the intermediate transfer belt 30. The time when the image forming units 20Y, 20M, 20C, 20K transfer the toner images onto the intermediate transfer belt 30 is adjusted by detection of a reference mark applied to the intermediate transfer belt 30. Thus, the toner images in yellow, magenta, cyan and black are superimposed on the intermediate transfer belt 30.

The toner image formed on the intermediate transfer belt 30 is transferred by a second transfer roller 26 onto a paper conveyed by a timing roller 31 with use of the effect of an electric field force. The paper to which the toner image is transferred is conveyed to a pair of fuser rollers 32, and is heated and pressurized by the pair of fuser rollers 32. Thus, the toner is fused and fixed to the paper. Thereafter, the paper is discharged to a paper discharge tray 39.

A belt cleaning blade 28 is provided in the upstream of the image forming unit 20Y of the intermediate transfer belt 30. The belt cleaning blade 28 removes the toner that has not been transferred to a paper and is residual on the intermediate transfer belt 30.

Papers in different sizes are respectively set in paper feed cassettes 35, 35A, 35B. The papers respectively stored in the paper feed cassettes 35, 35A, 35B are supplied to a conveyance path by outlet rollers 36, 36A, 36B respectively attached to the paper feed cassettes 35, 35A, 35B and sent to the timing roller 31 by paper feed rollers 37.

In the case where forming a full color image, the MFP 100 drives all of the image forming units 20Y, 20M, 20C, 20K. However, in the case where forming a monochrome image, the MFP 100 drives one of the image forming units 20Y, 20M, 20C, 20K. Further, the MFP 100 can form an image by a combination of two or more than two of the image forming units 20Y, 20M, 20C, 20K. While a tandem-system MFP 100 including the image forming units 20Y, 20M, 20C, 20K that respectively form images on a paper by using toner of four colors is described here, a four-cycle system MFP that sequentially transfers the toner of four colors to a paper using one photoreceptor drum may be used.

Next, developing devices 24Y, 24M, 24C, 24K will be described. While storing toner in different colors, the developing devices 24Y, 24M, 24C, 24K have the same configuration. Here, the developing device 24Y is described as an example.

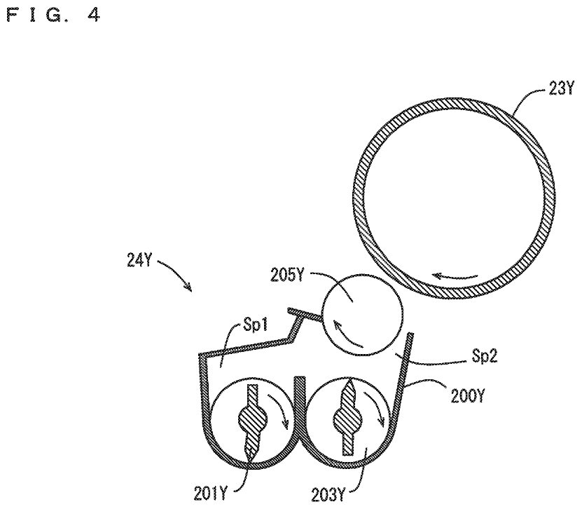

FIG. 4 is a cross sectional view of the developing device. The top-and-down direction on a sheet of paper of FIG. 4 is defined as a top-and-bottom direction, and the direction vertical to a sheet of paper is defined as a front-and-rear direction. The developing device 24Y includes a casing 200Y, a stirring screw 201Y, a supply screw 203Y and a development roller 205Y.

The casing 200Y stores a developer, the stirring screw 201Y, the supply screw 203Y and the development roller 205Y. The casing 200Y extends in the front-and-rear direction and has a stirring space Sp1 and a supply space Sp2 being adjacent to each other in the left-and-right direction. The stirring space Sp1 is provided at a position further leftward than the supply space Sp2 in the casing 200Y. The stirring space Sp1 and the supply space Sp2 are connected to each other at both ends in the front-and-rear direction.

The stirring screw 201Y is provided in the stirring space Sp1 and extends in the front-and-rear direction. The stirring screw 201Y is rotated by a motor, thereby conveying the developer from a rear position to a front position while stirring the developer. Thus, the toner is negatively charged, and the carrier is positively charged. The developer conveyed by the stirring screw 201Y flows into the supply space Sp2 from the front end of the stirring space Sp1.

The supply screw 203Y is provided in the supply space Sp2 and extends in the front-and-rear direction. The supply screw 203Y is rotated by a motor, thereby conveying the developer from the front position to the rear position. Then, the developer conveyed by the supply screw 203Y flows into the stirring space Sp1 from the rear end of the supply space Sp2. Thus, the developer circulates between the stirring space Sp1 and the supply space Sp2.

The development roller 205Y is provided in the supply space Sp2 and extends in the front-and-rear direction. Thus, the development roller 205Y is opposite to the supply screw 203Y. Further, the development roller 205Y is exposed from the casing 200Y and is opposite to the photoreceptor drum 23Y. A magnet is incorporated in the development roller 205Y, so that the development roller 205Y attracts a magnetic carrier by a magnetic force together with non-magnetic toner, and carries the developer that has been conveyed by the supply screw 203Y.

A sensor for detecting an amount of developer in the casing 200Y is attached to the casing 200Y. In the case where the amount of developer detected by the sensor is smaller than a certain value, the developer is supplied to the casing 200Y from the toner hopper 42Y.

The development roller 205Y supplies the toner to the photoreceptor drum 23Y and develops an electrostatic latent image. Specifically, a developing bias is applied to the development roller 205Y. Thus, the potential of the peripheral surface of the development roller 205Y is lower than the potential (substantially 0 V) of the portion, irradiated with a laser beam emitted by the exposure device 21Y, of the peripheral surface of the photoreceptor drum 23Y and higher than the potential of the portion, not irradiated with the laser beam, of the peripheral surface of the photoreceptor drum 23Y. The non-magnetic toner in the developer carried by the development roller 205Y is negatively charged, thereby adhering to the portion, irradiated with a laser beam, on the peripheral surface of the photoreceptor drum 23Y. Thus, a toner image is formed on the peripheral surface of the photoreceptor drum 23Y by the negatively charged toner.

Next, deterioration of toner stored in the developing device 24Y will be described. The toner stored in the developing device 24Y deteriorates by being stirred by the developing device 24Y. The deterioration of toner represents a phenomenon such as separation of an external additive added to the toner from the toner or burial of the external additive in the toner. The degree of deterioration correlates to the time during which the toner is stirred in the developing device 24Y. In the present embodiment, the unit representing an amount of stress on the developer caused by stirring is referred to as a deterioration amount. The deterioration amount is the value correlating to the deterioration of toner stored in the developing device 24Y. Here, the developing device 24Y is to be driven each time the MFP 100 forms an image on a recording medium, and the unit representing the deterioration amount is the number of printed sheets. The number of printed sheets indicates the number of times the MFP 100 forms an image on a recording medium, and the number of sheets of a recording medium on which images are formed. Further, the deterioration state of the toner stored in the developing device 24Y is an average value of the deterioration amount of the toner stored in the developing device 24Y.

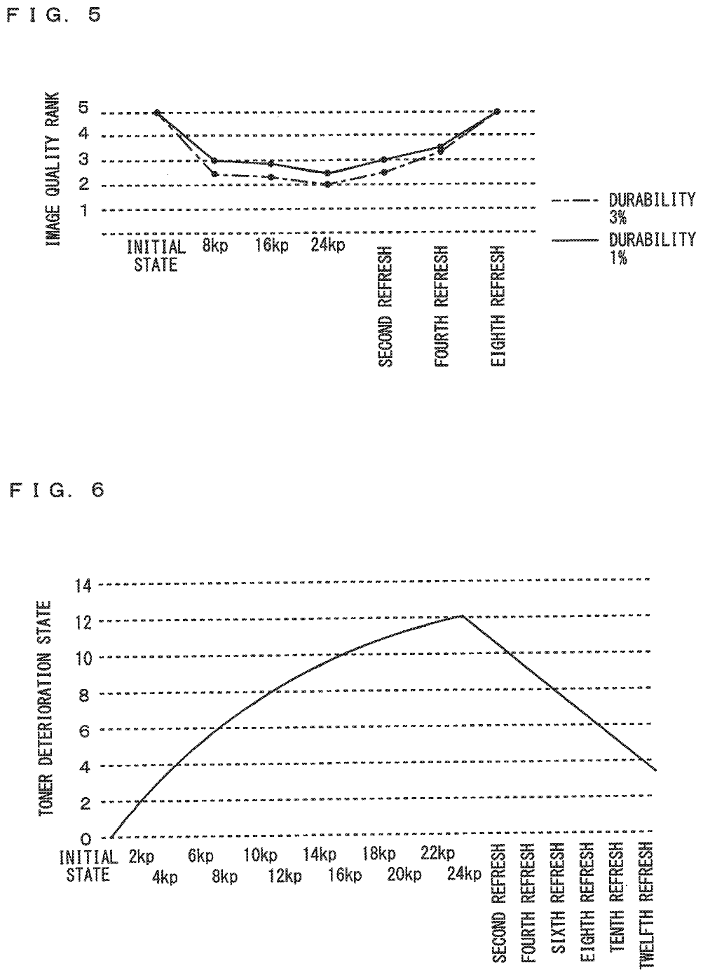

FIG. 5 is a diagram showing the change in image quality rank. Referring to FIG. 5, the abscissa indicates the number of printed sheets, and the ordinates indicates the image quality rank. The image quality rank represents the result of visual inspection of the image quality of a toner image formed on a paper by the MFP 100. The rank 5 represents the highest image quality, and the rank 1 represents the lowest image quality. The graph shown in FIG. 5 shows the result of an experiment in which the MFP 100 forms images. The condition of the experiment is that the MFP 100 forms images of the image data, the printing rate of which is 1%, until the number of printed sheets becomes 24 kp, and then the toner refresh control for replacing the toner by a certain amount is executed eight times. Note that kp represents 1000 sheets. FIG. 5 shows each result of visual assessment of the image quality of an image formed on a paper when the number of printed sheets is 8 kp, 16 kp or 24 kp, and shows each result of visual assessment of the image quality of an image formed on a paper each time the toner refresh control is executed twice. In an initial state where the number of printed sheets is 1 to 100 sheets, the image quality rank is 5. Then, the image quality rank is lowered each time the number of printed sheets increases. After the number of printed sheets becomes 24 kp, the image quality rank is raised each time the number of times the toner refresh control is executed increases. The image quality rank is recovered to 5 when the toner refresh control is executed for the 8th time.

FIG. 6 is a diagram showing one example of the change in deterioration state of the toner stored in the developing device. The change shown in FIG. 6 indicates the change in deterioration state of the toner stored in the developing device 24Y in the experiment of FIG. 5. Here, the unit representing the deterioration state of the toner is kp. The unit representing the deterioration state of the toner is not limited to kp but another unit such as the time during which the toner is stirred in the developing device 24Y may be used. Referring to FIG. 6, the abscissa indicates the number of printed sheets, and the ordinate indicates the deterioration state of the toner stored in the developing device 24Y. In the initial state where the number of printed sheets is 1 to 100 sheets, the deterioration state of the toner stored in the developing device 24Y is 0.

The average deterioration amount increases as the number of printed sheets increases. The deterioration state of the toner stored in the developing device 24Y is about 6 kp when the number of printed sheets is 8 kp. Further, FIG. 6 shows the case where the deterioration state of the toner stored in the developing device 24Y at the time point at which the number of printed sheets is 24 kp is about 12 kp, and then the toner refresh control is executed twelve times.

In the change in image quality rank shown in FIG. 5, the image quality rank is recovered at the time point at which the toner refresh control is executed eight times. In contrast, in FIG. 6, the deterioration state of the toner stored in the developing device 24Y is about 6 kp when the toner refresh control is executed for the 8th time. Prior to the execution of the toner refresh control, the deterioration state of the toner stored in the developing device 24Y is about 6 kp in the case where the number of printed sheets is 8 kp. In contrast, in the change in image quality rank shown in FIG. 5, the image quality rank is equal to or lower than 3 when the number of printed sheets is 8 kp.

Suppose that the deterioration state of the toner stored in the developing device 24Y must be 2 kp in order for the image quality rank to be maintained at 3. According to the result shown in FIG. 6, after execution of the toner refresh control is started, the deterioration state of the toner stored in the developing device 24Y is 2 kp when the toner is refreshed more than 8 times. Therefore, although the image quality level is recovered, the toner refresh control is executed. Thus, the toner is consumed wastefully, and the time during which the toner refresh control is executed is lengthened.

Therefore, in the case where the number of times the toner is refreshed is determined based on the deterioration state of the toner stored in the developing device 24Y, the accurate number of times the toner is to be refreshed cannot be obtained.

Therefore, in the MFP 100 in the present embodiment, the toner refresh control is executed based on the deterioration state of the toner, which is immediately before being transferred to a paper from the intermediate transfer belt 30.

Toner deteriorates when an external additive is separated from the toner or buried in the toner. In the present embodiment, silica, which was the representative of the external additive, was subject to measurement, and the experiment in which an amount of silica on the surface of toner was measured was carried out.

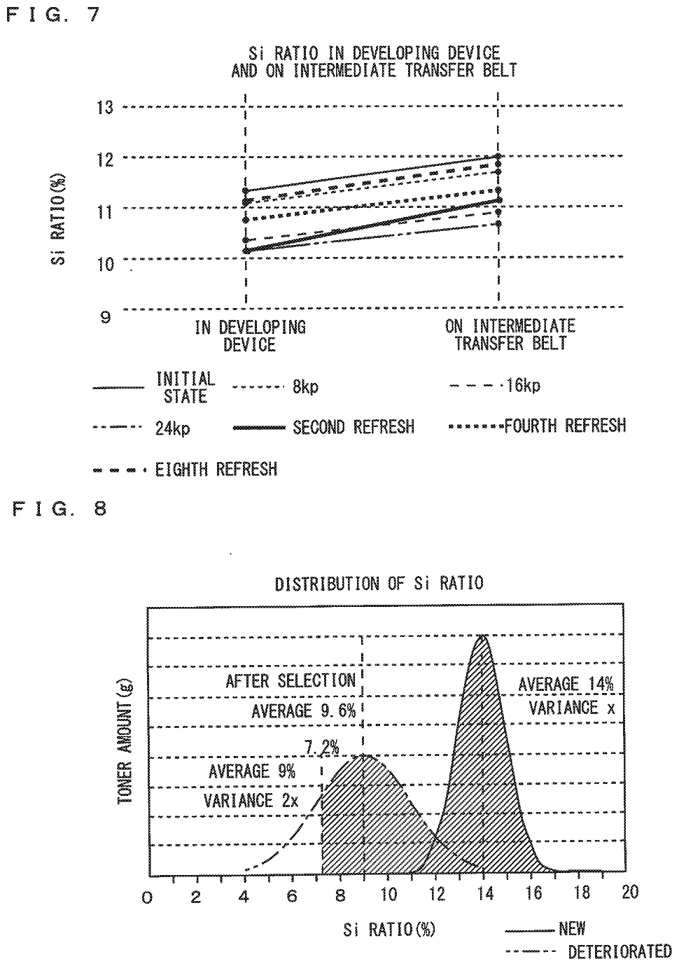

FIG. 7 is a diagram showing one example of the Si ratio of the toner stored in the developing device and the Si ratio of the toner that constitutes a toner image formed on the intermediate transfer belt. The Si ratio is the percentage of an area including silica in the surface of toner. In the experiment, the toner amount and the deterioration amount of the toner stored in the developing device 24Y and the toner amount and deterioration amount of the toner that was transferred from the developing device 24 to the intermediate transfer belt 30 through the photoreceptor drum 23Y were measured. The Si ratio was measured in regards to each of the toner in the developing device 24Y and the toner that constituted a toner image formed on the intermediate transfer belt 30 in each of the case where the number of printed sheets indicated the initial state, or is 8 kp, 16 kp or 24 kp, and the case where the toner refresh control was executed two times, four times or eight times. The plurality of Si ratios of the toner were measured in the experiment, and the average value was calculated. Referring to FIG. 7, the Si ratio of the toner on the intermediate transfer belt 30 is higher than the Si ratio of the toner stored in the developing device 24Y in any of the case where the number of printed sheets indicates the initial state, or is 8 kp, 16 kp or 24 kp, or the case where the toner refresh control is executed two times, four times or eight times. This shows that the toner, having a small deterioration amount, in the toner stored in the developing device 24Y is preferentially supplied to the photoreceptor drum 23Y and transferred to the intermediate transfer belt 30.

From the results of experiment shown in FIG. 7, the toner that constitutes the toner image that is transferred to the intermediate transfer belt 30 can be considered as a group of toner, having a small deterioration amount, of all of the toner stored in the developing device 24Y.

FIG. 8 is a diagram showing one example of distributions of the Si ratios of the new toner and the deteriorated toner that are stored in the developing device. When the Si ratio of the toner stored in the developing device 24Y was measured in the experiment, the average of the Si ratio of the new toner was 14%, and the average of the Si ratio of the deteriorated toner was 9%. Referring to FIG. 8, it is assumed that the Si ratio is normally distributed, and the distribution of the Si ratio of the new toner is shown in the normal distribution with the average assumed to be 14% and the variance assumed to be x. The distribution of the Si ratio of the deteriorated toner is shown in the normal distribution with the average assumed to be 9% and the variance assumed to be 2x. From the relationship between the Si ratio of the toner stored in the developing device and the Si ratio of the toner that constitutes a toner image formed on the intermediate transfer belt 30, it is considered that the distribution of the Si ratio of the deteriorated toner, of the toner transferred to the intermediate transfer belt 30 from the toner stored in the developing device 24Y, is normally distributed with the average being 9.6% and the variance being 2x. From this result, it is considered that the toner, the Si ratio of which is equal to or higher than 7.2%, out of the toner stored in the developing device 24Y has been transferred to the intermediate transfer belt. It was found that the percentage of the toner, the Si ratio of which was equal to or higher than 7.2%, in the toner stored in the developing device 24Y was 80%.

As shown in FIG. 7, the differences between the Si ratio of the toner transferred to the intermediate transfer belt 30 and the Si ratio of the toner stored in the developing device 24Y are substantially the same regardless of the number of printed sheets. Therefore, it is considered that, even when groups of toner have different average values of the Si ratios, if the distributions of the Si ratios are the same, the selected percentage of the toner stored in the developing device 24Y is constant. The selected percentage is the percentage of the toner, the Si ratio of which is equal to or higher than a reference value, in the toner stored in the developing device 24Y when the lowest value of the Si ratio of the toner transferred to the intermediate transfer belt 30 is set as the reference value.

In the case where the Si ratio of the toner stored in the developing device 24Y is distributed differently, the selected percentage differs. Next, the relationship between the distribution of the Si ratio of the toner stored in the developing device 24Y and the selected percentage is studied.

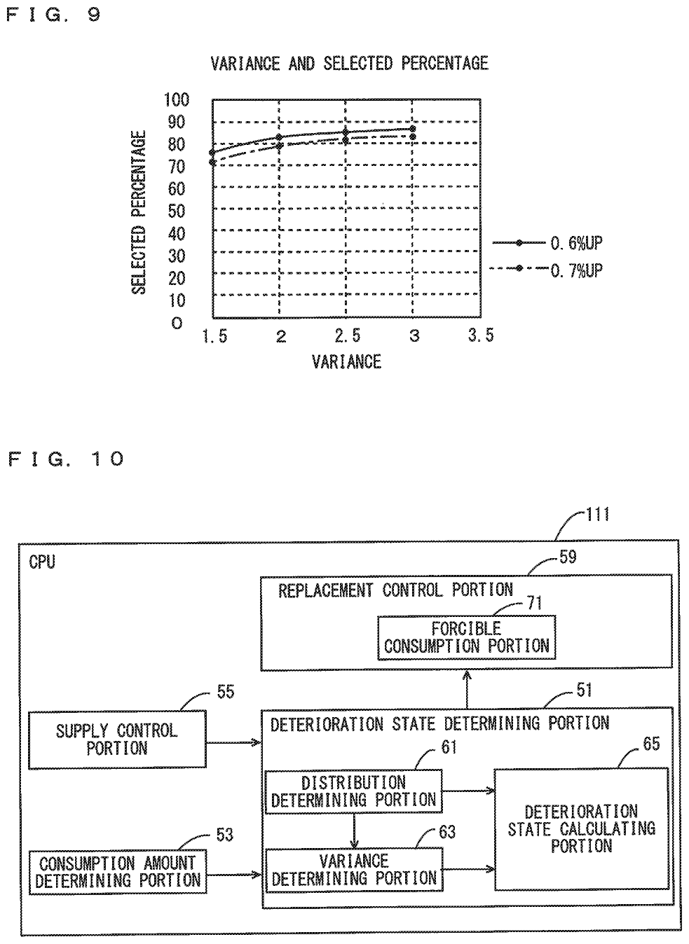

FIG. 9 is a diagram showing one example of the variance of the Si ratio of the toner stored in the developing device and the selected percentage. FIG. 9 shows the results of experiment in which the Si ratio of the toner stored in the developing device 24Y is equal to or higher than 0.6% and 0.7%. From the results of experiment shown in FIG. 9, even when the variances are different from each other, the selected percentages are between 70% and 90%. When the variance is high, the selected percentage is about 90% and saturated. Therefore, 70 to 90% of the toner, having a low deterioration amount, out of the toner stored in the developing device 24Y is transferred to the intermediate transfer belt 30. Further, if the relationship between the variance of the deterioration amount of the toner stored in the developing device 24Y and the selected percentage is defined, the selected percentage can be obtained from the variance of the deterioration amount of the toner stored in the developing device 24Y. Here, the variance percentage data defining the relationship between the variance of the deterioration amount of the toner stored in the developing device 24Y and the selected percentage is predetermined by way of example.

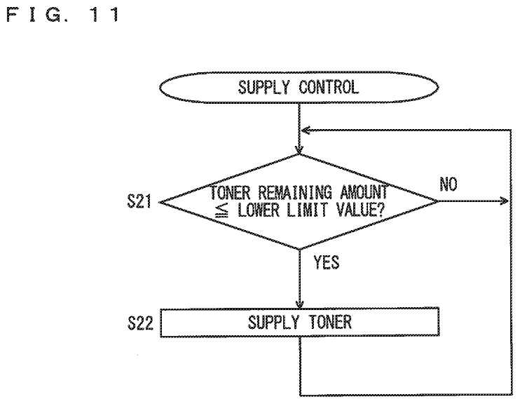

FIG. 10 is a block diagram showing one example of the functions of the CPU included in the MFP in the present embodiment. The functions of the CPU 111 shown in FIG. 10 are realized by the CPU 111 when the CPU 111 included in the MFP 100 executes a deterioration state detection program stored in the ROM 113, the HDD 115 or the CD-ROM 118A. While the CPU 111 executes the toner refresh control on each of the developing devices 24Y, 24M, 24C, 24K, the same control method is used. Here, the toner refresh control that is executed on the developing device 24Y is described by way of example.

Referring to FIG. 10, the CPU 111 includes a deterioration state determining portion 51, a consumption amount determining portion 53, a supply control portion 55 and a replacement control portion 59.

The consumption amount determining portion 53 determines an amount of toner to be consumed by the developing device 24Y as a consumption amount. The consumption amount determining portion 53 outputs the consumption amount to the deterioration state determining portion 51. The consumption amount determining portion 53 calculates the amount of toner to be consumed with respect to the image data from the printing rate defined by the image data that is subject to the image formation, and calculates the consumption amount by integrating the amount of toner that is consumed each time an image is formed. The consumption amount determining portion 53 may calculate the amount of toner to be consumed with respect to the image data using the transfer efficiency in addition to the printing rate, the transfer efficiency representing the percentage of the toner amount to be actually transferred to a recording medium with respect to a theoretical value of the toner amount calculated based on the image data. Further, the consumption amount determining portion 53 may calculate the consumption amount from an amount detected by a concentration detection sensor for detecting the toner concentration of the developer stored in the developing device 24Y and an amount detected by a developer amount detection sensor for detecting an amount of developer stored in the developing device 24Y.

When the amount of the developer stored in the developing device 24Y becomes equal to or lower than a certain amount, the supply control portion 55 controls the toner hopper 42Y and allows the toner hopper 42Y to supply the toner to the developing device 24Y. In response to the remaining amount of the toner stored in the developing device 24Y becoming equal to or lower than a predetermined lower limit value, the supply control portion 55 rotates the screw included in the toner hopper 42Y to supply the toner to the developing device 24Y. Further, the amount of tonner to be supplied during one rotation of the screw included in the toner hopper 42Y is predetermined as a unit supply amount, and the supply control portion 55 calculates the toner amount supplied from the toner hopper 42Y to the developing device 24Y from the rotation amount of the screw as a supply amount. The supply control portion 55 outputs the supply amount to the deterioration state determining portion 51.

The deterioration state determining portion 51 determines the deterioration state of the toner immediately before being transferred from the intermediate transfer belt 30 to a paper. The deterioration state determining portion 51 includes a distribution determining portion 61, a variance determining portion 63 and a deterioration state calculating portion 65.

A certain amount of toner is successively supplied to the developing device 24Y from the toner hopper 42Y. Therefore, the toner stored in the developing device 24Y includes a group of toner having the same deterioration amount with respect to each of a plurality of deterioration amounts. The distribution determining portion 61 determines the distribution of the toner amount with respect to the deterioration amount in regards to the toner stored in the developing device 24Y based on the consumption amount received from the consumption amount determining portion 53 and the supply amount received from the supply control portion 55. The distribution determining portion 61 determines the distribution each time a unit supply amount of toner is supplied from the toner hopper 42Y to the developing device 24Y. The deterioration amount of toner supplied from the toner hopper 42Y is zero. When the toner is supplied from the toner hopper 42Y, the distribution determining portion 61 corrects the distribution of the deterioration amount of the toner stored in the developing device 24Y to the distribution of the deterioration amount of the toner to which the toner supplied from the toner hopper 42Y is added.

Further, each time the toner stored in the developing device 24Y is consumed, the distribution determining portion 61 determines the distribution of the deterioration amount of the toner stored in the developing device 24Y. For example, the distribution determining portion 61 determines the distribution each time the number of printed sheets increases by 1 kp. Specifically, the distribution determining portion 61 increases the deterioration amount of the toner stored in the developing device 24Y by 1 kp. Further, the distribution determining portion 61 reduces the amount of toner included in the group by a consumption rate for each group of toner having the same deterioration amount. For example, letting the total amount of toner stored in the developing device 24Y be MS, and letting the amount of toner that has been consumed be MC, the consumption rate is MC/MS. Letting the amount of toner included in the group of toner having the same deterioration amount be MA, the remaining amount MR of the group of toner remaining in the developing device 24Y is MR=MA*MC/NS.

The variance determining portion 63 determines the variance of the deterioration amount of the toner stored in the developing device 24Y each time distribution of the deterioration amount of the toner stored in the developing device 24Y is determined by the distribution determining portion 61.

The deterioration state calculating portion 65 determines the selected percentage corresponding to the variance determined by the variance determining portion 63 with reference to the variance percentage data. The value of the selected percentage is from 60 to 90%.

The deterioration state calculating portion 65 determines a target toner based on the distribution of the toner amount determined by the distribution determining portion 61. The target toner is the toner stored in the developing device 24Y and the deterioration amount of which is equal to or lower than a certain value. Further, the percentage of the target toner in all of the toner stored in the developing device 24Y is equal to or higher than a selected percentage. The deterioration state calculating portion 65 selects groups of toner in the order of ascending deterioration amount from among the toner stored in the developing device 24Y until the percentage of the selected toner in all of the toner stored in the developing device 24Y becomes equal to or higher than the selected percentage, thereby determining the selected toner as the target toner. Specifically, the deterioration state calculating portion 65 determines the amount of toner corresponding to the selected percentage in all of the toner stored in the developing device 24Y as a selected amount. Then, the deterioration state calculating portion 65 selects the toner having the same deterioration amount from among the toner stored in the developing device 24Y and put them in groups in the order of ascending deterioration amount until the total amount of toner becomes the selected amount, and calculates a cumulative toner amount of the selected groups. The deterioration state calculating portion 65 determines the groups of toner selected at the time point at which the cumulative value of the toner amount exceeds the selected amount as the target toner. The deterioration state calculating portion 65 determines the average value of the deterioration amount of the target toner as the deterioration state of toner immediately before being transferred from the intermediate transfer belt 30 to a paper.

In the case where the average value of the toner deterioration amount calculated by the deterioration state calculating portion 65 becomes equal to or higher than a predetermined upper limit threshold value TH2, the deterioration state determining portion 51 outputs a replacement instruction to the replacement control portion 59.

In response to reception of the replacement instruction, the replacement control portion 59 replaces the toner stored in the developing device 24Y. The replacement control portion 59 includes a forcible consumption portion 71. The forcible consumption portion 71 controls the image forming unit 20Y and allows the exposure device 21Y to expose the photoreceptor drum 23Y based on the consumption data. Thus, an electrostatic latent image formed by the exposure device 21Y on the photoreceptor drum 23Y is developed by the developing device 24Y and the toner stored in the developing device 24Y is consumed. The consumption data is predetermined image data, and preferably maximizes the amount of toner, that is stored in the developing device 24Y and is to be supplied to the photoreceptor drum 23Y, for example. This is for the purpose of making the amount of toner, which is stored in the developing device 24Y and is to be consumed each time the development is carried out by the developing device 24Y, be as large as possible. For example, the consumption data is the data representing a solid image in yellow. The toner image formed on the photoreceptor drum 23Y is transferred to the intermediate transfer belt 30 and then collected by the belt cleaning blade 28. Further, the second transfer roller 26 is retracted to a position away from the intermediate transfer belt 40.

When the toner stored in the developing device 24Y is consumed, and the amount of developer becomes equal to or lower than a certain amount, a unit supply amount of new toner is supplied to the developing device 24Y from the toner hopper 32Y. The forcible consumption portion 71 controls the image forming unit 20Y until the deterioration state, determined by the deterioration state determining portion 51, of the toner immediately before being transferred to a paper from the intermediate transfer belt 30 becomes an enabled state, and allows the exposure device 21Y to expose the photoreceptor drum 23Y based on the consumption data. The enabled state is the state where the average value of the deterioration amount of the target toner is equal to or lower than a predetermined enabled threshold value TH1.

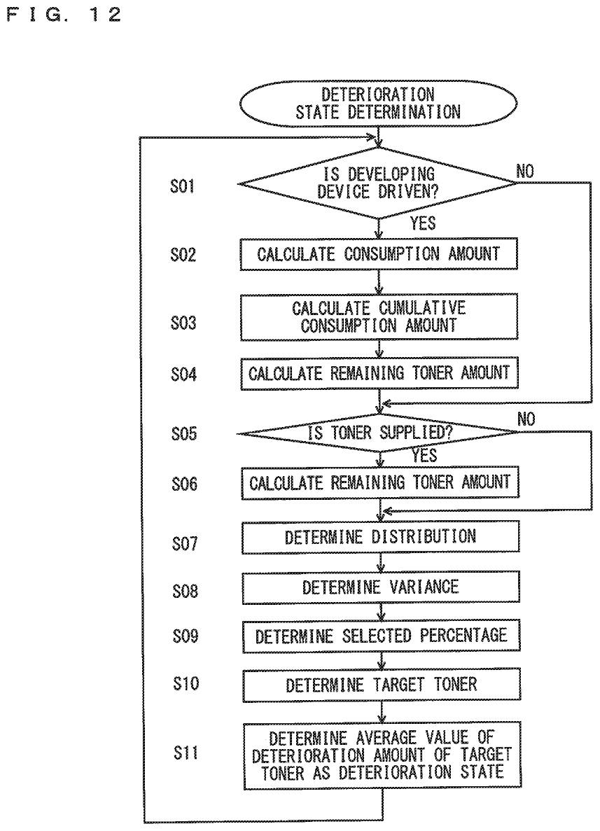

FIG. 11 is a flow chart showing one example of a flow of a supply control process. The supply control process is executed by the CPU 111 when the CPU 111 included in the MFP 100 executes the deterioration state detection program stored in the ROM 113, the HDD 115 or the CD-ROM 118A. Referring to FIG. 11, the CPU 111 determines whether the remaining amount of toner stored in the developing device 24Y is equal to or lower than a lower limit value. The process waits until the remaining amount of toner becomes equal to or lower than the lower limit value (NO in the step S21). If the remaining amount of toner is equal to or lower than the lower limit value, the process proceeds to the step S22. In the step S22, toner is supplied to the developing device 24, and the process returns to the step S21. Specifically, the CPU 111 controls the toner hopper 42Y and allows the toner hopper 42Y to supply a unit supply amount of toner to the developing device 24Y.

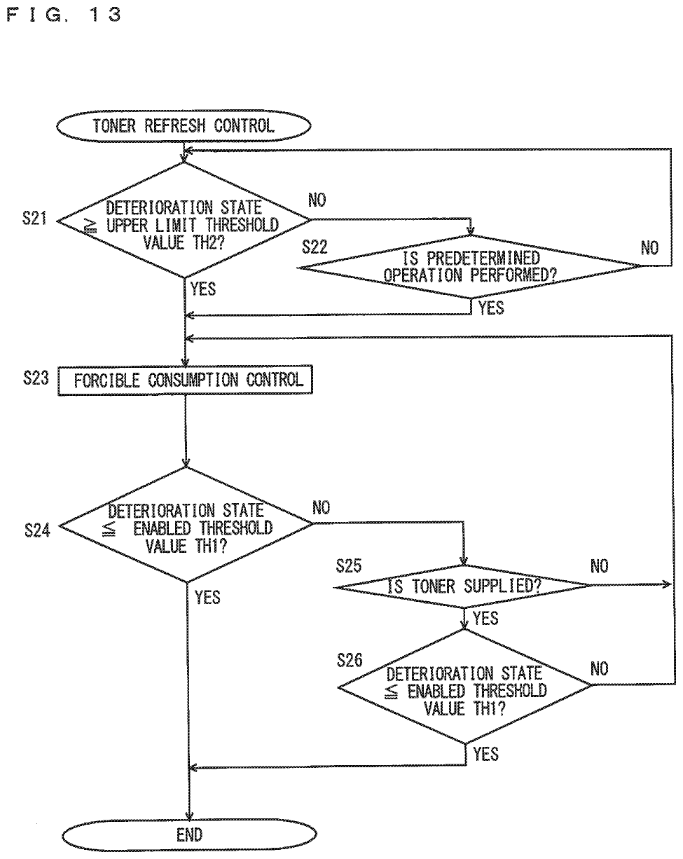

FIG. 12 is a flow chart showing one example of a flow of a deterioration state detection process. The deterioration state detection process is executed by the CPU 111 when the CPU111 included in the MFP 100 executes the deterioration state detection program stored in the ROM 113, the HDD 115 or the CD-ROM 118A. Referring to FIG. 12, the CPU 111 determines whether the developing device 24Y has been driven (step S01). If the developing device 24Y is driven, the process proceeds to the step S02. If not, the process proceeds to the step S05. The developing device 24Y is driven in the case where the image forming unit 140 forms an image on a paper, which is a recording medium, the case where the image forming unit 140 forms a toner image for testing on the intermediate transfer belt for calibration, etc.

In the step S02, the CPU 111 calculates a consumption amount. The CPU 111 calculates the amount of toner consumed by the developing device 24Y as a consumption amount based on the image data that is output to the exposure device 21Y in order to form an electrostatic latent image on the photoreceptor drum 23Y. In the next step S03, the CPU 111 calculates the cumulative consumption amount, and the process proceeds to the step S04. The CPU 111 calculates the cumulative consumption amount by accumulating the consumption amounts calculated in the step S02. In the step S04, the CPU 111 calculates the amount of toner stored in the developing device 24Y as a remaining toner amount. The CPU 111 sets the value obtained by subtraction of the cumulative consumption amount from the remaining toner amount, which is calculated before execution of the step S04, as a new remaining toner amount.

In the step S05, the CPU 111 determines whether toner has been supplied to the developing device 24Y. If the toner is supplied from the toner hopper 42Y to the developing device 24Y, the process proceeds to the step S06. If not, the process proceeds to the step S07. In the step S06, the remaining toner amount is calculated, and the process proceeds to the step S07. The CPU 111 sets the value obtained by addition of the unit supply amount to the remaining toner amount, which is calculated before execution of the step S04, as a new remaining toner amount.

In the step S07, the CPU 111 determines the distribution of the deterioration amount of toner stored in the developing device 24Y, and the process proceeds to the step S08. In the step S08, the CPU 111 determines the variance of the deterioration amount of the toner stored in the developing device 24Y, and the process proceeds to the step S09. In the step S09, the CPU 111 determines the selected percentage corresponding to the variance of the deterioration amount of toner, and the process proceeds to the step S10. In the step S10, the CPU 111 determines the target toner, and the process proceeds to the step S11. Specifically, the CPU 111 determines the toner amount corresponding to the selected percentage in the amount of all of the toner stored in the developing device 24Y as a selected amount. Then, the CPU 111 selects groups of the toner having the same deterioration amount from the toner stored in the developing device 24Y in the order of ascending deterioration amount, and then integrates the amounts of toner in the selected groups until the cumulative amount of toner in the selected groups becomes the selected amount. The CPU 111 determines the selected groups of toner as target toner at the time point at which the cumulative value of the toner amount exceeds the selected amount.

In the step S11, the CPU 111 determines the average value of the deterioration amount of the target toner as the deterioration state of the toner immediately before being transferred from the intermediate transfer belt 30 to a paper, and the process returns to the step S01.

FIG. 13 is a flow chart showing one example of a flow of a toner refresh control process. The toner refresh control process is executed by the CPU 111 when the CPU 111 included in the MFP 100 executes the deterioration state detection program stored in the ROM 113, the HDD 115 or the CD-ROM 118A. Referring to FIG. 13, the CPU 111 determines whether the deterioration state determined by execution of the deterioration state detection process is equal to or higher than the upper limit threshold value TH2 (step S21). The deterioration state determined by execution of the deterioration state detection process is the average value of the deterioration amount of the target toner, and represents the deterioration state of the toner immediately before being transferred from the intermediate transfer belt 30 to a paper. If the deterioration state determined by execution of the deterioration state determination process is equal to or higher than the upper limit threshold value TH2, the process proceeds to the step S23. If not, the process proceeds to the step S22.

In the step S22, the CPU 111 determines whether a certain operation is received. If the certain operation is received, the process proceeds to the step S23. If not, the process returns to the step S21. The certain operation is a predetermined operation. The certain operation is an operation of designating the button to which an operation of giving an instruction for executing the toner refresh is assigned, for example. The button to which the operation of giving an instruction for executing the toner refresh is assigned is displayed in the display unit 161. When the touch panel 165 detects the designation of the button by the user, the certain operation is received. Further, the certain operation may be a user's operation of giving an instruction for forming an image with a predetermined type of a recording medium being set as a print condition. The predetermined type is an embossed paper, for example. The embossed paper is the paper on which an embossing process is performed and to which a raised and recessed pattern is applied. Further, the predetermined type may be a thick paper or a coated paper. Further, the certain operation may be a user's operation of giving an instruction for forming an image with the image forming condition according to the certain image quality being set. For example, the image forming conditions for forming images of certain image qualities include an image forming condition for forming a high resolution image, an image forming condition for forming an image in which the density changes smoothly and an image forming condition for forming an image in a picture mode, high image quality mode or the like in which importance is placed on image quality.

In the step S23, the CPU 111 executes the forcible consumption control, and the process proceeds to the step S24. Specifically, the CPU 111 controls the exposure device 21Y and allows an electrostatic latent image to be formed on the photoreceptor drum 23Y in accordance with the consumption data. Thus, the electrostatic latent image is developed by the toner stored in the developing device 24Y, and the toner stored in the developing device 24Y is consumed.

In the step S24, the CPU 111 determines whether the deterioration state determined by execution of the deterioration state detection process is equal to or higher than an enabled threshold value TH1. If the deterioration state determined by execution of the deterioration state detection process is equal to or higher than the enabled threshold value TH1, the process ends. If not, the process proceeds to the step S25. In the step S25, the CPU 111 determines whether the toner is supplied to the developing device 24Y. If the toner is supplied from the toner hopper 42Y, the process proceeds to the step S26. If not, the process returns to the step S23. In the step S26, similarly to the step S24, the CPU 111 determines whether the deterioration state determined by execution of the deterioration state detection process is equal to or higher than the enabled threshold value TH1. If the deterioration state determined by execution of the deterioration state detection process is equal to or higher than the enabled threshold value TH1, the process ends. If not, the process returns to the step S23.

In the step S21, the CPU 111 determines whether the deterioration state determined by execution of the deterioration state detection process is equal to or higher than the upper limit threshold value TH2. In the case where the deterioration state determined by execution of the deterioration state detection process is equal to or higher than the upper limit threshold value TH2, the CPU 111 executes the process that follows the step S23.

Therefore, the toner is replaced during the image formation, so that the image quality can be maintained. The process following the step S23 does not have to be executed while the MFP 100 is being operated by the user, but may be executed after the image forming operation that is based on a user's instruction ends. Therefore, the toner refresh control can be prevented from being executed while the user is operating the MFP 100, so that the user does not have to wait. Further, the deterioration state of the toner, immediately before being transferred from the intermediate transfer belt 30 to a paper, may be estimated before execution of the step S21, and the estimated value may be compared with the upper limit threshold value TH2. In this case, the toner is replaced before the image is formed, so that the image quality of an image to be formed on a paper can be prevented from being degraded.

As described above, the MFP 100 in the present embodiment can easily determine the deterioration state of the toner immediately before being transferred to a paper, which is a recording medium, from the intermediate transfer belt 30. Therefore, the image quality of the toner image transferred to the paper, which is a recording medium, can be accurately detected.

Further, the MFP 100 determines the deterioration state of the toner supplied from the developing device 24Y to the photoreceptor drum 23Y based on the deterioration amount of the target toner, the target toner being selected in the order of ascending deterioration amount from the toner stored in the developing device 24Y until the percentage of the target toner in all of the toner stored in the developing device 24Y becomes equal to or higher than the selected percentage. Therefore, the deterioration state of the toner immediately before being transferred from the intermediate transfer belt 30 to a paper, which is a recording medium, can be accurately determined.

Further, since determining the selected percentage based on the variance of the deterioration amount of the toner stored in the developing device 24Y, the MFP 100 can accommodate a difference in variance of the deterioration amount of the toner stored in the developing device 24Y.

Further, the MFP 100 determines the deterioration state of the toner immediately before being transferred from the intermediate transfer belt 30 to a paper, which is a recording medium, based on the consumption amount of the toner stored in the developing device 24Y and the supply amount of toner from the toner hopper 42Y to the developing device 24Y. Therefore, the deterioration state of the toner immediately before being transferred from the intermediate transfer belt 30 to a paper, which is a recording medium, can be easily determined.

Further, because determining the consumption amount of toner based on the image data that is subject to image formation, the MFP 100 can easily determine the consumption amount of toner.

Further, the MFP 100 allows the developing device 24Y to consume toner based on the consumption data, which is predetermined image data. Thus, the developing device 24Y can consume as large amount of toner as possible.

Further, in the case where the average value of the deterioration amount of the target toner is equal to or higher than the upper limit threshold value TH2, the MFP 100 replaces at least part of the toner stored in the developing device 24Y. Thus, the MFP 100 can appropriately determine the time when the toner is to be replaced. Thus, the number of times the toner refresh control is executed is reduced as much as possible, so that the toner can be prevented from being consumed wastefully.

Further, the MFP 100 replaces at least part of the toner stored in the developing device 24Y until the deterioration state of the toner immediately before being transferred from the intermediate transfer belt 30 to a paper, which is a recording medium, becomes the enabled state. Thus, the amount of toner to be replaced by the toner refresh control can be as small as possible, and the toner can be prevented from being consumed wastefully.

In the present embodiment, the deterioration amount of toner is defined by the number of printed sheets, which represents the number of times toner images that have been transferred from the photoreceptor drum 23Y to the intermediate transfer belt 30 are transferred to a recording medium such as a paper by the second transfer roller 26 while the toner is being stored in the developing device 24Y. However, the deterioration amount of toner may be defined by a cumulative time during which the developing device 24Y is driven. Further, the deterioration amount of toner may be defined by a development drive distance representing the distance by which the outer peripheral surface of the development roller 205Y travels. In this case, the development drive distance can be used in the case where the rotation speed of the development roller 205Y of the developing device 24Y is changeable. In the case where the deterioration amount of toner is defined by the cumulative time during which the developing device 24Y is driven or the development drive distance, the component of toner deterioration caused by the developing device 24Y being driven while an image is not being formed on a recording medium is included in the deterioration amount. Thus, the deterioration amount of toner can be accurately determined.

Further, the deterioration amount of toner may be defined by the number of times the developing device 24Y develops electrostatic latent images formed on the photoreceptor drum 23Y while the toner is being stored in the developing device 24Y.

Further, the deterioration amount of toner in each of the developing devices 24M, 24C, 24K can be obtained by the method similar to the method used to obtain the deterioration amount of the toner stored in the developing device 24Y. The time when execution of the toner refresh control is to be started in each of the developing devices 24Y, 24M, 24C, 24K can be determined. In other words, the toner refresh control may be executed simultaneously in the developing devices 24M, 24C, 24K, or may be executed at different times.

While the deterioration amount of the toner stored in the developing device 24Y is calculated each time the number of printed sheets becomes 1 kp. However, the deterioration amount of the toner stored in the developing device 24Y may be calculated more frequently or less frequently.

The developability and transferability of toner differ depending on a difference in image formation condition such as configuration of the image forming unit 20Y or a bias voltage in an electrophotographic process and a difference in type of toner. Therefore, the variance percentage data defining the relationship between the variance of the deterioration amount of toner and the selected percentage may be defined with respect to the image forming condition and the type of toner. Further, the selected percentage may be a value preset in the MFP 100.

Further, the deterioration state of the toner immediately before being transferred from the intermediate transfer belt 30 to a paper, which is a recording medium, in other words, the average value of the deterioration amount of the target toner can be utilized for another control that is not the toner refresh control. For example, the average value of the deterioration amount of the target toner may be utilized for the control of determining a voltage applied to the first transfer roller 25Y and the control of determining a voltage applied to a second transfer roller.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming apparatus comprising:
a developing device that stores a developer including toner;
an image carrier that carries a toner image produced by part of the toner stored in the developing device; and
a controller, wherein
the controller determines a deterioration state of the toner, immediately before being supplied to a recording medium from the image carrier, based on a deterioration amount correlating to deterioration of the toner stored in the developing device.

2. The image forming apparatus according to claim 1, wherein
the controller determines the deterioration state of the toner, immediately before being supplied to a recording medium from the image carrier, based on the deterioration amount of target toner that is selected from the toner stored in the developing device in order of ascending deterioration amount until a ratio of the target toner to all of the toner stored in the developing device becomes equal to or higher than a predetermined ratio.

3. The image forming apparatus according to claim 2, wherein
the controller determines the predetermined ratio based on variance of the deterioration amount of the toner stored in the developing device.

4. The image forming apparatus according to claim 2, wherein
the controller determines the deterioration state based on a consumption amount of the toner stored in the developing device, and a supply amount of the toner to be supplied to the developing device.

5. The image forming apparatus according to claim 4, wherein
the controller determines the consumption amount of the toner stored in the developing device based on image data that is subjected to image formation.

6. The image forming apparatus according to claim 2, wherein
the controller controls the developing device such that at least part of the toner stored in the developing device is replaced based on the determined deterioration state.

7. The image forming apparatus according to claim 6, wherein
the deterioration state is an average value of the deterioration amount of the target toner, and
the controller, in the case where the average value of the deterioration amount of the target toner is equal to or higher than an upper limit threshold value, controls the developing device such that at least part of the toner stored in the developing device is replaced.

8. The image forming apparatus according to claim 6, wherein
the controller, in response to reception of a user's predetermined operation, controls the developing device such that at least part of the toner stored in the developing device is replaced.

9. The image forming apparatus according to claim 6, wherein
the controller controls the developing device such that at least part of the toner stored in the developing device is replaced until the determined deterioration state becomes an enabled state.

10. The image forming apparatus according to claim 9, wherein
the enabled state is a state where an average value of the deterioration amount of the target toner is equal to or lower than an enabled threshold value.

11. The image forming apparatus according to claim 6, wherein
the controller allows the developing device to consume the toner based on predetermined consumption data.

12. The image forming apparatus according to claim 2, wherein
the deterioration amount of the toner is a cumulative time during which the developing device is driven.

13. The image forming apparatus according to claim 2, wherein
the deterioration amount of toner is the number of times the developing device produces the toner image while the toner is being stored in the developing device.

14. The image forming apparatus according to claim 2, further comprising a transfer roller that transfers the toner image carried by the image carrier to a recording medium, wherein
the deterioration amount of the toner is the number of times the transfer roller transfers the toner image carried by the image carrier to a recording medium while the toner is being stored in the developing device.

15. A deterioration state detection method that is executed in an image forming apparatus, the image forming apparatus comprising:
a developing device that stores a developer including toner; and
an image carrier that carries a toner image produced by part of the toner stored in the developing device, and
the deterioration state detection method including a deterioration state determining step of determining a deterioration state of the toner, immediately before being supplied to a recording medium from the image carrier, based on a deterioration amount correlating to deterioration of the toner stored in the developing device.

16. The deterioration state detection method according to claim 15, wherein
the deterioration state determining step includes determining the deterioration state of the toner, immediately before being supplied to a recording medium from the image carrier, based on the deterioration amount of target toner that is selected from the toner stored in the developing device in order of ascending deterioration amount until a ratio of the target toner to all of the toner stored in the developing device becomes equal to or higher than a predetermined ratio.

17. The deterioration state detection method according to claim 16, further including a ratio determining step of determining the predetermined ratio based on variance of the deterioration amount of the toner stored in the developing device.

18. The deterioration state detection method according to claim 16, wherein
the deterioration state determining step includes determining the deterioration state based on a consumption amount of the toner stored in the developing device, and a supply amount of the toner to be supplied to the developing device.

19. The deterioration state detection method according to claim 18, further including a consumption amount determining step of determining the consumption amount of the toner stored in the developing device based on image data that is subject to image formation.

20. A non-transitory computer-readable recording medium encoded with a deterioration state detection program executed by a computer controlling an image forming apparatus,
the image forming apparatus comprising:
a developing device that stores a developer including toner; and
an image carrier that carries a toner image produced by part of the toner stored in the developing device, and
the deterioration state detection program allowing the computer to execute a deterioration state determining step of determining a deterioration state of the toner, immediately before being supplied to a recording medium from the image carrier, based on a deterioration amount correlating to deterioration of the toner stored in the developing device.
